(19) United States
(12) Patent Application Publication
(10) Pub. No.: US 2025/0147515 A1
(43) Pub. Date: May 8, 2025

(54) SYSTEMS AND METHODS FOR CONTROLLING AIRCRAFT DURING IN-FLIGHT REFUELING

(71) Applicant: THE BOEING COMPANY, Arlington, VA (US)

(72) Inventors: Dallas Steven Scholes, Buckley, WA (US); Eric Paul Oman, Lake St. Louis, MO (US); Jonathon Farmer, Maryland Heights, MO (US); John Robert Ulrich, Glen Carbon, IL (US)

(73) Assignee: THE BOEING COMPANY, Arlington, VA (US)

(21) Appl. No.: 18/502,220

(22) Filed: Nov. 6, 2023

(51) Int. Cl. G05D 1/10; B64D 39/00; B64D 47/00

(52) U.S. Cl. CPC G05D 1/104; B64D 39/00; G06V 20/58

(57) ABSTRACT

A system and a method are configured for allowing a first vehicle to refuel a second vehicle. The system and the method include sensors configured to acquire scan data of the second vehicle. A control unit is in communication with the sensors. The control unit is configured to receive the scan data of the second vehicle from the sensors, associate the scan data with a three-dimensional (3D) model of the second vehicle, register the scan data with the 3D model to provide monitored data of the second vehicle, and control one or more of the first vehicle, the second vehicle, or a refueling boom of the first vehicle based on the monitored data.

### FIELD OF THE DISCLOSURE

Examples of the present disclosure generally relate to systems and methods for controlling aircraft during in-flight refueling.

### BACKGROUND OF THE DISCLOSURE

During a flight, an aircraft may need to be refueled. Certain aircraft are fuel tankers that are configured to refuel another aircraft during a flight. For example, a fuel tanker may include a boom or drogue that is extended behind the fuel tanker during a flight. The boom is coupled to a fuel line. A trailing aircraft is maneuvered to the end of the boom, which is then attached to a fuel inlet probe of the trailing aircraft. After the boom of the fuel tanker is connected to the fuel inlet of the trailing aircraft, an in-flight refueling of the trailing aircraft occurs.

Typically, a pilot of the trailing aircraft maneuvers the trailing aircraft in relation to the fuel tanker. A boom operator in a fuel tanker aircraft operates control devices to ensure that the probe is directed to a receptacle of a receiving aircraft. Once the fuel inlet is connected to the boom, the pilot continues to manually operate the control devices of the trailing aircraft to ensure that the fuel inlet remains coupled to the boom as the trailing aircraft is refueled. Typically, as the trailing aircraft is being refueled, the pilot ensures that the trailing aircraft maintains position in relation to the fuel tanker, which is known as station-keeping. Station-keeping also occurs while the trailing aircraft is queuing to be refueled, and other forms of formation flight. After the refueling process, the connection between the probe of the trailing aircraft and the boom of the fuel tanker is disconnected (disengagement), and the refueled aircraft continues flight.

The process of maneuvering a trailing aircraft in relation to the fuel tanker, and manually controlling the trailing aircraft (as well as the boom of the fuel tanker) during the refueling process requires a high level of skill, experience, and communication. In certain situations, such as during periods of turbulence, a pilot may have difficulty maneuvering the trailing aircraft in relation to the fuel tanker before and after the connection between the boom and the fuel inlet is attained (engagement and disengagement).

Also, one or more cameras on the refueling aircraft are typically used to assist a boom operator during a boom connection process. The operator can view images or video acquired by the camera(s) to guide the boom to a fuel port of the trailing aircraft. However, atmospheric conditions, such as rain, glare from sunlight, and/or the like, can distort the acquired images or video, and thereby hinder the refueling operation.

### SUMMARY OF THE DISCLOSURE

A need exists for an improved system and method for refueling an aircraft during a flight. Further, a need exists for an improved system and a method for refueling an aircraft that will eliminate, minimize, or otherwise reduce issues that could arise from potential distortions in acquired video or photographic images acquired from a camera.

With those needs in mind, certain examples of the present disclosure provide a system configured for allowing a first vehicle to refuel a second vehicle. The system includes sensors configured to acquire scan data of the second vehicle. A control unit is in communication with the sensors. The control unit is configured to receive the scan data of the second vehicle from the sensors, associate the scan data with a three-dimensional (3D) model of the second vehicle, register the scan data with the 3D model to provide monitored data of the second vehicle, and control one or more of the first vehicle, the second vehicle, or a refueling boom of the first vehicle based on the monitored data. In a further example, the control unit is configured to automatically control the first vehicle, the second vehicle, and the refueling boom based on the monitored data.

The 3D model can be previously stored in a model database. The control unit can be further configured to generate the 3D model by recognizing one or more features within the scan data. For example, the one or more features are on a fuel port of the second vehicle.

In at least one example, the first vehicle is a first aircraft, and the second vehicle is a second aircraft.

In at least one example, the first vehicle includes the sensors. The sensors do not include a photographic camera or a video camera. The sensors can include one or more of light detection and ranging (LIDAR) sensors, lasers, infrared sensors, ultrasonic sensors, radio detection and ranging (RADAR) sensors, sound navigation ranging (SONAR) sensors, microwave sensors, UHF/SHF/EHF or THF frequency emission sensors, and/or the like.

The system can also include a user interface including a display. The control unit is further configured to show information regarding a refueling process on the display. For example, the control unit is further configured to show a preferable location for refueling on the display.

The system can also include an imaging device that is separate and distinct from the sensors. The imaging device is configured to acquire photographic images or video of the second vehicle.

In at least one example, the control unit includes an artificial intelligence or machine learning system.

The control unit can be further configured to record atmospheric data during each refueling operation to allow for artificial intelligence to learn and determine desired environments for future refueling operations.

Certain examples of the present disclosure provide a system including a first aircraft including a refueling boom and sensors. A second aircraft includes a fuel port. A control unit is in communication with the sensors. The control unit includes an artificial intelligence or machine learning system. The control unit is configured to receive scan data of the second vehicle from the sensors, associate the scan data with a three-dimensional (3D) model of the second vehicle, register the scan data with the 3D model to provide monitored data of the second vehicle, control one or more of the first aircraft, the second aircraft, or a refueling boom of the first aircraft based on the monitored data, and record atmospheric data during each refueling operation to allow for the artificial intelligence or machine learning system to learn and determine desired environments for future refueling operations.

Certain examples of the present disclosure provide a method for allowing a first vehicle to refuel a second vehicle. The method includes acquiring, by sensors of the first vehicle, scan data of the second vehicle; receiving, by a control unit in communication with the sensors, the scan data of the second vehicle from the sensors; associating, by the control unit, the scan data with a three-dimensional (3D) model of the second vehicle; registering, by the control unit, the scan data with the 3D model to provide monitored data of the second vehicle; and controlling, by the control unit, one or more of the first vehicle, the second vehicle, or a refueling boom of the first vehicle based on the monitored data.

### BRIEF DESCRIPTION OF THE DRAWINGS

FIG. 1 illustrates a schematic block diagram of a system, according to an example of the present disclosure.

FIG. 2 illustrates a perspective view of a first aircraft refueling a second aircraft, according to an example of the present disclosure.

FIG. 3 illustrates a flow chart of a method, according to an example of the present disclosure.

FIG. 4 illustrates a front view of a display, according to an example of the present disclosure.

FIG. 5 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

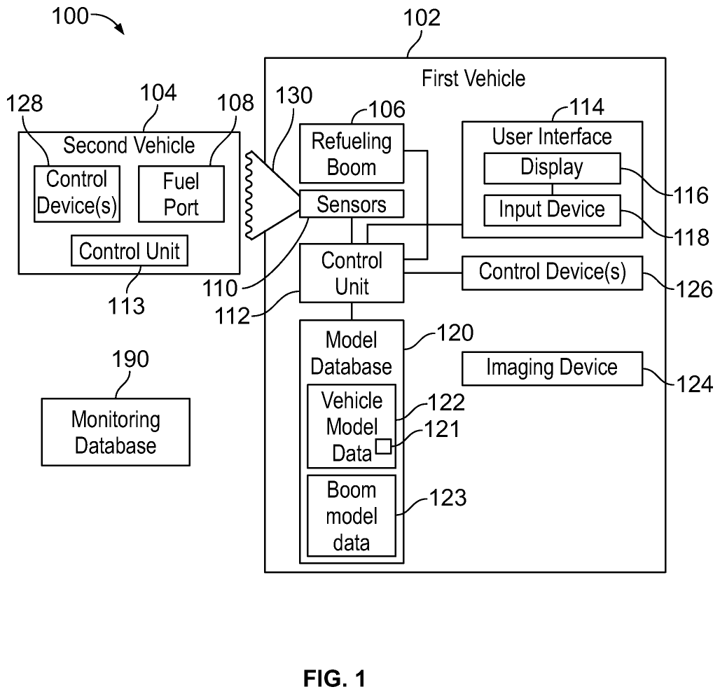

FIG. 1 illustrates a schematic block diagram of a system 100, according to an embodiment of the present disclosure. The system 100 includes a first vehicle 102 that is configured refuel a second vehicle 104. In at least one example, the first vehicle 102 is a first aircraft and the second vehicle 104 is a second aircraft. In at least one example, the first aircraft 102 leads (for example, in front) the second aircraft 104, which trails (that is, behind) that first aircraft 102. In at least one other example, the first vehicle 102 and/or the second vehicle 104 is a ground based vehicle, such as an automobile, bus, locomotive, military vehicle (such as a tank), and/or the like. In at least one example, the first vehicle 102 and/or the second vehicle 104 is a spacecraft, watercraft, or the like. In at least one example, the first vehicle 102 is an aeronautical or aerospace vehicle, and the second vehicle 104 is a land-based or water-based vehicle. It is to be understood that the terms first and second are merely for labeling purposes. The first vehicle can be the second vehicle, and vice versa.

In at least one example, the first vehicle 102 is a fuel tanker, such as a KC-46, manufactured by The Boeing Company, and the second vehicle 104 is a military fighter jet, such as an F-15, manufactured by The Boeing Company. As another example, one or both of the first vehicle 102 or the second vehicle 104 is/are an unmanned aircraft, such as an unmanned aerial vehicle, drone, or the like.

The first vehicle 102 includes a refueling boom 106 that is configured to extend from the first vehicle 102. The refueling boom 106 is configured to be guided to and into a fuel port 108 of the second vehicle 104.

The first vehicle 102 also includes sensors 110 that are configured to scan the second vehicle 104. In at least one example, multiple sensors 110 are used to scan the second vehicle 104 and generate scan data of the second vehicle 104. The scan data can include a three-dimensional point cloud of the second vehicle 104. In at least one example, the sensors 110 are not photographic or video cameras. Instead, the sensors 110 are configured to acquire data other than photographic images or video of the second vehicle 104. The sensors 110 can include light detection and ranging (LIDAR) sensors, lasers, infrared sensors, ultrasonic sensors, radio detection and ranging (RADAR) sensors, sound navigation ranging (SONAR) sensors, microwave sensors, UHF/SHF/EHF, or THF frequency emission sensors, and/or the like.

A control unit 112 is in communication with the sensors 110, such as through one or more wired or wireless connections. The control unit 112 is configured to receive the scan data from the sensors 110. In at least one example, the control unit 112 is onboard the first vehicle 102. As another example, the control unit 112 is onboard the second vehicle 104. As another example, the control unit 112 is remotely located from the first vehicle 102 and the second vehicle 104, such as onboard another vehicle, a ground based monitoring station, or the like.

In at least one example, the first vehicle and 102 and the second vehicle 104 can be in communication with one another, such as through one or more communication devices or links. The first vehicle 102 and the second vehicle 104 can communicate with one another to facilitate autonomous operation, such as to provide automatic docking procedures, for example. For example, the second vehicle 104 can also include a control unit 113 that is communication with the control unit 112 of the first vehicle 102. The control unit 113 can be configured to automatically control the control device(s) of the second vehicle 104 and coordinate with operation of the first vehicle 102, which can be controlled by the control unit 112.

The control unit 112 is also in communication with a user interface 114, which can also be onboard the first vehicle 102. The user interface 114 includes a display 116, such as an electronic monitor, screen, an electronic heads-up display, augmented or virtual reality glasses, or smart glasses, which can be used to reduce eye strain, headache, vertigo, and/or the like. The display 116 can be in communication with an input device 118, such as a keyboard, a mouse, a stylus, a joystick, and/or the like. In at least one example, the display 116 and input device 118 are integrated as a touchscreen interface. The user interface 114 may be part of a computer workstation onboard the first vehicle 102. As another example, the user interface 114 can be part of a handheld smart device within the first vehicle 102. Optionally, the user interface 114 can be onboard the second vehicle 104. As another example, the user interface 114 can be remote from the first vehicle 102 and the second vehicle 104, such as onboard another vehicle, a ground based monitoring station, or the like.

The control unit 112 is also in communication with a model database 120, which stores vehicle model data 122. As shown, the model database 120 can be onboard the first vehicle 102. As another example, the model database 120 can be onboard the second vehicle 104. As another example, the model database 120 can be remote from the first vehicle 102 and the second vehicle 104, such as onboard another vehicle, a ground based monitoring station, a cloud-based database, and/or the like. The vehicle model data 122 (which can include one or more 3D models 121) is related to one or more vehicle models, such as computer aided design (CAD) models of the first vehicle 102, the second vehicle 104, the refueling boom 106, the fuel port 108, and the like.

The first vehicle 102 can also include an imaging device 124, which can be in communication with the control unit 112, such as through one or more wired or wireless connections. In contrast to the sensors 110, the imaging device 124 is configured to acquire photographic images and/or video, such as of the second vehicle 104. For example, the imaging device 124 can be a photographic camera, a video camera, or the like. Optionally, the first vehicle 102 does not include the imaging device 124.

The first vehicle 102 also includes one or more control devices 126 configured to control operation of the first vehicle 102. In at least one example, the control unit 112 is in communication with the control devices 126, such as through one or more wired or wireless connections. As described herein, in at least one example, the control unit 112 is configured to automatically control the control devices 126 of the first vehicle 102 to automatically control operation of the first vehicle 102. The control devices 126 are operatively coupled to various components of the first vehicle 102, such as engines, control surfaces on wings, stabilizers, etc., and the like. The control devices 126 can include one or more of a yoke, stick, joystick, pedals, buttons, switches, keyboards, touchscreens, and/or the like that are configured to control the various components of the first vehicle 102. The control devices 126 can be onboard the first vehicle 102 (such as within a cockpit or flight deck), or remotely located from the first vehicle 102, such as if the first vehicle 102 is an unmanned aerial vehicle.

The second vehicle 104 also includes one or more control devices 128 configured to control operation of the second vehicle 104. In at least one example, the control unit 112 is in communication with the control devices 128, such as through wireless connections and communications. As described herein, in at least one example, the control unit 112 is configured to automatically control the control devices 128 of the second vehicle 104 to automatically control operation of the second vehicle 104. The control devices 128 are operatively coupled to various components of the second vehicle 104, such as engines, control surfaces on wings, stabilizers, etc., and the like. The control devices 128 can include one or more of a yoke, stick, joystick, pedals, buttons, switches, keyboards, touchscreens, and/or the like that are configured to control the various components of the second vehicle 104. The control devices 128 can be onboard the second vehicle 104 (such as within a cockpit or flight deck), or remotely located from the second vehicle 104, such as if the second vehicle 104 is an unmanned aerial vehicle.

In operation, the sensors 110 are configured to acquire scan data of the second vehicle 104 within a scan field 130, such as within a predetermined distance in relation to the first vehicle 102. The sensors 110 acquire the scan data of the second vehicle 104 and the refueling boom 106. Multiple sensors 110 positioned on and/or within portions of the first vehicle 102 are used to acquire scan data that includes 3D point cloud data of the second vehicle 104 and the refueling boom 106.

The control unit 112 receives the scan data of the second vehicle 104 from the sensors 110. In response to receiving the scan data of the second vehicle 104, the control unit 112 compares the scan data with the vehicle model data 122 stored within the model database 120. If the control unit 112 determines that the scan data matches a vehicle within the vehicle model data 122 (such as a particular type of aircraft), the control unit 112 then determines the location of the fuel port 108 of the second vehicle 104 within the vehicle model data 122. The control unit 112 then registers the vehicle model data 122 of the particular vehicle with the scan data of the second vehicle 104 received from the sensors 110. For example, the control unit 112 analyzes the scan data of the second vehicle 104 in relation to the vehicle model data 122, which includes a 3D model 121 of the second vehicle 104. In particular, the control unit 112 moves and manipulates (for example, virtually moves and manipulates) the 3D model 121 of the second vehicle 104, as stored in the vehicle model data 122, to match the scan data of the second vehicle 104, and overlays the 3D model 121 (including the location of the fuel port 108) onto the scan data.

In a similar manner, the control unit 112 further registers boom model data 123 stored within the model database 120 with the scan data of the refueling boom 106. The control unit 112 then determines positions of the refueling boom 106 in relation to the fuel port 108 from model data of the second vehicle 104 and the refueling boom 106 and the scan data of the second vehicle 104 and the refueling boom 106 (in contrast to photographic or video data). The control unit 112 determines the position of the fuel port 108 in relation to the refueling boom 106 from the model data and the scan data. The control unit 112 then automatically controls one or both of the control device(s) 126 and/or the control device(s) 128, and/or the refueling boom 106 to automatically connect the refueling boom 106 to the fuel port 108.

During such operation, the imaging device 124 can be used to acquire photographic and/or video images of the second vehicle 104 and/or the refueling boom 106. The images can be shown on the display 116 of the user interface 114. The images acquired by the imaging device 124 can be used to monitor the refueling operation. Optionally, the imaging device 124 is not used to acquire images during a refueling operation.

In at least one example, the model data registered with the scan data can be shown on the user interface 114. In at least one example, the control unit 112 may not automatically control operation of the first vehicle 102, the second vehicle 104, and/or the refueling boom 106. Instead, an operator can view the model data registered with the scan data on the display 116 and control the refueling boom 106 to connect with the fuel port 108.

In at least one example, the scan data of the second vehicle 104 may not match the vehicle model data 122 stored within the model database 120. As such, the control unit 112 receives the scan data of the second vehicle 104, and determines that there is no match within the vehicle model data 122. In response, the control unit 112 searches the scan data for features that are predetermined to be associated with the fuel port 108. Information regarding the features is stored in the model database 120, and/or a memory coupled to the control unit 112. The features can include a predetermined size, shape. structure (such as a door and/or opening), markings, and/or the like that are associated with the fuel port 108. In response to finding the features associated with the fuel port 108, the control unit 112 generates a 3D model for the second vehicle 104, which is then stored in the model database 120 as vehicle model data 122. The control unit 112 can then operate to control a refueling operation, as described.

In at least one example, the refueling boom 106 can be monitored and tracked, such as via the control unit 112 (in communication with the refueling boom 106 through one or more wired or wireless connections). Positions and/or orientations of the refueling boom 106 can be monitored by the control unit 112, which can update a 3D model of the refueling boom 106 in real time.

In at least one example, the first vehicle 102 can be in communication with a ground-based monitoring or control center, such as through one or more antennas, transceivers, and/or the like. The monitoring or control center can provide operational instructions and/or orders to the first vehicle 102.

As described herein, the system 100 is configured to allow the first vehicle 102 to refuel the second vehicle 104. The system 100 includes the sensors 110 configured to acquire scan data of the second vehicle 104. The control unit 112 is in communication with the sensors 110. The control unit 112 is configured to receive the scan data of the second vehicle 104 from the sensors 110, associate the scan data with a three-dimensional (3D) model of the second vehicle 104 (for example, the 3D model is stored in the model database 120), register the scan data with the 3D model to provide monitored data of the second vehicle 104, and control one or more of the first vehicle 102, the second vehicle 104, or a refueling boom 106 of the first vehicle 102 based on the monitored data. The monitored data includes the 3D model registered with (such as overlayed on) the scan data, which includes real time location and position data of the second vehicle 104, as detected by the sensors 110. In at least one example, the control unit 112 automatically controls the first vehicle 102, the second vehicle 104, and the refueling boom 106.

As used herein, the term “control unit,” “central processing unit,” “unit,” “CPU,” “computer,” or the like can include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 112 can be or include one or more processors that are configured to control operation thereof, as described herein.

The control unit 112 is configured to execute a set of instructions that are stored in one or more data storage units or elements (such as one or more memories), in order to process data. For example, the control unit 112 can include or be coupled to one or more memories. The data storage units can also store data or other information as desired or needed. The data storage units can be in the form of an information source or a physical memory element within a processing machine. The one or more data storage units or elements can comprise volatile memory or nonvolatile memory, or can include both volatile and nonvolatile memory. As an example, the nonvolatile memory can comprise read only memory (ROM), programmable ROM (PROM), electrically programmable ROM (EPROM), electrically erasable PROM (EEPROM), and/or flash memory and volatile memory can include random access memory (RAM), which can act as external cache memory. The data stores of the disclosed systems and methods is intended to comprise, without being limited to, these and any other suitable types of memory.

The set of instructions can include various commands that instruct the control unit 112 as a processing machine to perform specific operations such as the methods and processes of the various embodiments of the subject matter described herein. The set of instructions can be in the form of a software program. The software can be in various forms such as system software or application software. Further, the software can be in the form of a collection of separate programs, a program subset within a larger program or a portion of a program. The software can also include modular programming in the form of object-oriented programming. The processing of input data by the processing machine can be in response to user commands, or in response to results of previous processing, or in response to a request made by another processing machine.

The diagrams of embodiments herein illustrate one or more control or processing units, such as the control unit 112. It is to be understood that the processing or control units can represent circuits, circuitry, or portions thereof that can be implemented as hardware with associated instructions (e.g., software stored on a tangible and non-transitory computer readable storage medium, such as a computer hard drive, ROM, RAM, or the like) that perform the operations described herein. The hardware can include state machine circuitry hardwired to perform the functions described herein. Optionally, the hardware can include electronic circuits that include and/or are connected to one or more logic-based devices, such as microprocessors, processors, controllers, or the like. Optionally, the control unit 112 can represent processing circuitry such as one or more of a field programmable gate array (FPGA), application specific integrated circuit (ASIC), microprocessor(s), and/or the like. The circuits in various embodiments can be configured to execute one or more algorithms to perform functions described herein. The one or more algorithms can include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

In at least one example, all or part of the systems and methods described herein may be or otherwise include an artificial intelligence (AI) or machine-learning system that can automatically perform the operations of the methods also described herein. For example, the control unit 112 can be an artificial intelligence or machine learning system. These types of systems may be trained from outside information and/or self-trained to repeatedly improve the accuracy with how data is analyzed to automatically determine economy speeds. Over time, these systems can improve by determining such information with increasing accuracy and speed, thereby significantly reducing the likelihood of any potential errors. For example, the AI or machine-learning systems can learn and determine features of aircraft, fuel ports, and/or the like to automatically determine locations within scanned data, and automatically generate 3D models. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination and location of various structures within scan data. The training minimizes conflicts and interference by performing an iterative training algorithm, in which the systems are retrained with an updated set of data (for example, data received before, during, and/or after each flight of aircraft) and based on the feedback examined prior to the most recent training of the systems. This provides a robust analysis model that can better determine locations, features, structures, and/or the like in a cost effective and efficient manner.

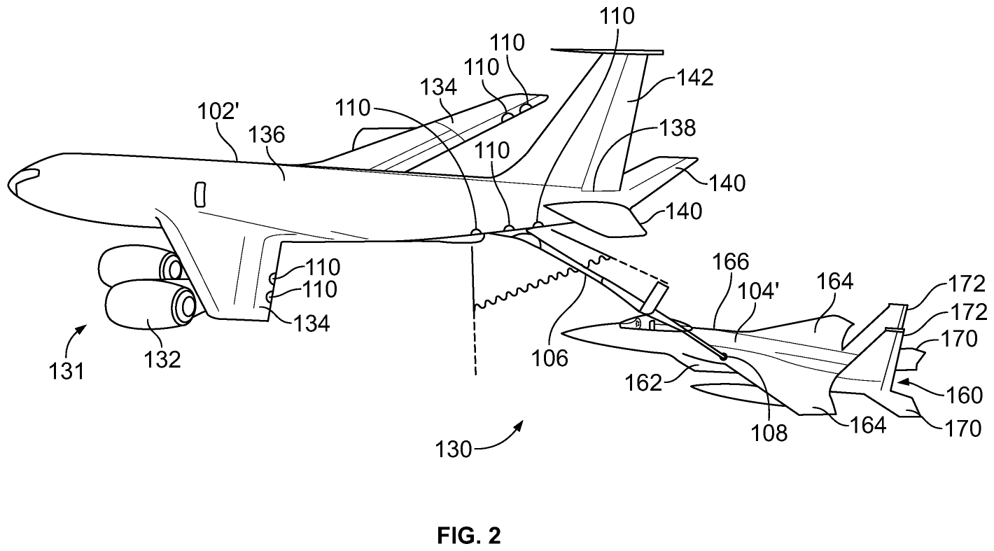

FIG. 2 illustrates a perspective view of a first aircraft 102′ refueling a second aircraft 104′, according to an example of the present disclosure. The first aircraft 102′ is an example of the first vehicle 102 (shown in FIG. 1), and the second aircraft 104′ is an example of the second vehicle 104 (also shown in FIG. 1). The first aircraft 102′ includes a propulsion system 131 that includes one or more engines 132, for example. The engines 132 are carried by wings 134 of the first aircraft 102′. In other examples, the engines 132 may be carried by a fuselage 136 and/or an empennage 138. The empennage 138 may also support horizontal stabilizers 140 and a vertical stabilizer 142. The second aircraft 104′ includes a propulsion system 160 that may include one or more engines 162, for example. The engines 162 are carried by wings 164 and/or a fuselage 166 of the second aircraft 104′. In other examples, the engines 162 may be carried by the fuselage 166 and/or an empennage, which may also support horizontal stabilizers 170 and vertical stabilizers 172. In at least one example, the first aircraft 102′ is a fuel tanker that extends a refueling boom 106 having a fuel line. The second aircraft 104′ includes a probe, which includes a fuel port 108.

As shown, the sensors 110 are disposed on or within the first aircraft 102′. For example, the sensors 110 can be disposed on or within a fuselage, wings, a tail, and/or the like of the first aircraft 102′. The sensors 110 acquire scan data of the second aircraft 104′ and the refueling boom 106 within the scan field 130. In at least one example, the scan data includes 3D point clouds of the second aircraft 104′ and the refueling boom 106 within the scan field 130.

Referring to FIGS. 1 and 2, examples of the present disclosure provide fully automated aerial identification and maneuver control systems. As described, the control unit 112 matches scan data of the second vehicle 104 with vehicle model data 122 stored within the model database 120. The control unit 112 can then automatically control one or more of the first vehicle 102, the second vehicle 104, and/or the refueling boom 106 based on the scan data of the second vehicle 104 and/or the refueling boom 106 to automatically refuel the second vehicle 104.

In at least one example, the control unit 112 is configured to automatically control operation of the first vehicle 102, the second vehicle 104, and/or the refueling boom 106 during an approach of the first vehicle 102 in relation to the second vehicle 104 (such as within a 500 feet or less range).

The control unit 112 can be or otherwise include an artificial intelligence, which can optimize operation over time. In at least one example, the control unit 112 allows for automated and manual adjustments during refueling operations managed by artificial intelligence. The control unit 112 can collect real-time refueling operations data during each refueling event, which can be used to further refine artificial intelligence operation.

As described herein, the system 100 provides an automatic scanning system for aircraft refueling operations to detect a receiving aircraft, such as the aircraft 104′ (that is, an aircraft to be refueled). The system 100 includes multiple sensors 110 configured to acquire scan data. The control unit 112 generates 3D geometry for the second vehicle 104 and the refueling boom 106 from the scan data acquired by the sensors 110 (which are not photographic or video cameras). If the scan data of the second vehicle 104 corresponds to a 3D model 121 within the vehicle model data 122 stored within the model database 120, the control unit 112 then synchronizes operational control of the first vehicle 102, the second vehicle 104, and/or the refueling boom 106 during a refuel process. The control unit 112 continues to scan data output by the sensors 110 to track the position of second vehicle 104 in relation to the first vehicle 102. The control unit 112 determines the location of the fuel port 108 from the scan data and the 3D model, and provides real-time symbiotic flight control to control approach, guidance towards the fuel port 108 and operation of the refueling boom 106.

In at least one example, the control unit 112 records atmospheric data (including altitude, time or day, cloud cover, precipitation, air turbulence, and/or the like) during each refueling operation to allow for artificial intelligence to learn and determine desired environments for refueling operations. The atmospheric data can be transmitted to a monitoring database 190, where it can be stored and shared with other vehicles.

Other vehicles proximate to the first vehicle 102 can communicate particular atmospheric data to the control unit 112, to provide the control unit 112 with options for a better refueling environment. Operators can further enter tactical restrictions for the control unit 112, such as during combat missions to exclude no fly areas, air exclusion zones (AEZ), and/or other restraints.

In at least one example, the control unit 112 can further show the refueling process on the display 116 of the user interface 114, which allows an individual to watch execution of a refueling docking process. Viewpoints of the 3D models shown on the display can be rendered from any vantage point. The rendered data can include visual indicia to inform individuals of relative distances between vehicles, booms, fuel ports, and/or the like. The control unit 112 can further provide information on the display regarding if a refueling connection is on track to be completed or not.

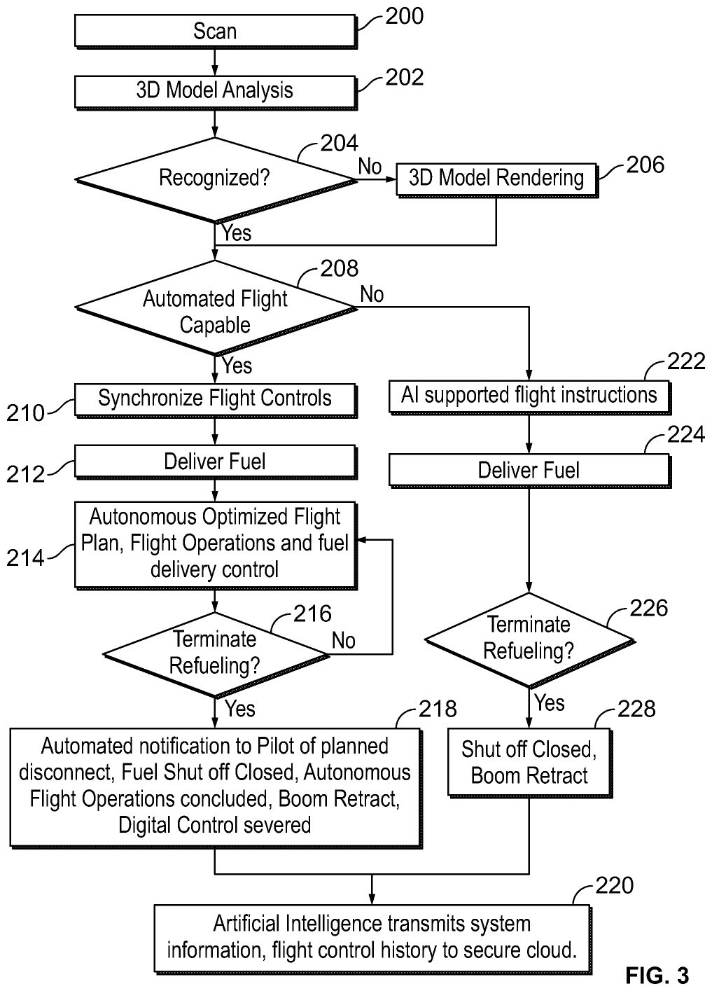

FIG. 3 illustrates a flow chart of a method, according to an example of the present disclosure. Referring to FIGS. 1 and 3, at 200, the sensors 110 scan the second vehicle 104 within the scan field 130, and output the scan data to the control unit 112. At 202, the control unit analyzes the scan data in relation to 3D model data stored within the model database 120. At 204, the control unit 112 determines if the scan data is recognized. That is, the control unit 112 determines if the scan data matches a 3D model stored within the model database 120. If the scan data is not recognized at 204, the method proceeds to 206, at which control unit 112 renders a new 3D model of the vehicle 104 based on recognizable features (such as the fuel port 108). The 3D model is then stored in the model database 120.

In response to associating the scan data with a 3D model (whether previously stored in the model database 120 or generated and stored in the model database 120 based on recognizable features), the method proceeds to 208, at which the control unit 112 determines if one or both of the first vehicle 102 and/or the second vehicle 104 is capable of automated flight. If so, the method proceeds to 210, at which the control unit 112 synchronizes flight controls 210 of the first vehicle 102 and/or the second vehicle 104. After the first vehicle 102, the second vehicle 104, and/or the refueling boom 106 are automatically operated by the control unit 112 to connect the refueling boom 106 with the fuel port 108, fuel is then delivered to the second vehicle 104 at 212. An autonomous optimized flight plan, flight operations, and fuel delivery are controlled by the control unit 112 at 214. At 216, the control unit 112 determines if refueling is to be terminated (such as by monitoring a fuel level of the second vehicle 104). If not, the method returns to 214. If, however, the refueling is to be terminated, the method proceeds from 216 to 218, at which the control unit 112 automatically notifies an operator of a planned disconnect, shuts off fuel delivery, terminates autonomous flight operations, retracts the refuel boom 106, and severs digital control. At 220, an artificial intelligence system of the control unit 112 can then transmit system information, flight control history, and/or the like to the monitoring database 190, which can be a secure cloud server.

If at 208, automated flight is not available, the method proceeds to 222, at which the control unit 112 can provide artificial intelligence supported instructions to the first vehicle 102 and/or the second vehicle 104 in order to connect the refueling boom 106 to the fuel port 108. After the refueling boom 106 is connected to the fuel port 108, fuel is delivered to the second vehicle 104 at 224. At 226, it is determined by an operator if refueling is to be terminated, such as by monitoring a fuel level of the second vehicle 104. If not, the method returns to 224. If, however, refueling is to be terminated at 226, the method proceeds to 228, at which fuel delivery is shut off, and the refueling boom 106 is retracted. The method can then proceed to 220.

In at least one example, an automated maintenance test can be performed by a control unit, such as the control unit 112, to ensure operational quality of the various components of the system, such as the sensors, software, database modeling, and the like. Results of the maintenance test can be sent to a monitoring or control center, and then to vehicle operators to provide system updates.

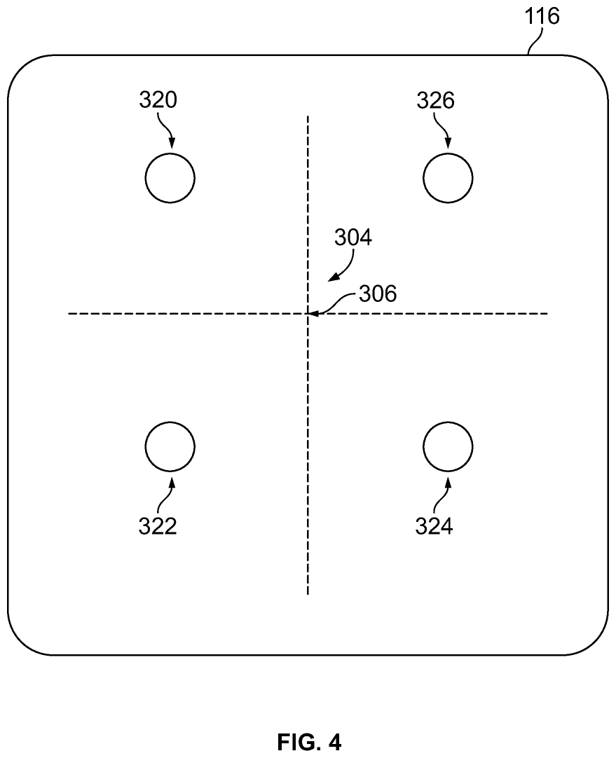

FIG. 4 illustrates a front view of the display 116, according to an example of the present disclosure. Referring to FIGS. 1 and 4, the control unit 112 can show a representation 304 of the second vehicle 104 on the display 116. The representation 304 includes a 3D model of the second vehicle 104 registered with (such as overlayed on) real time scan data of the second vehicle 104, as acquired by the sensors 110. The control unit 112 can also show a representation 306 of the refueling boom 106 in relation to the second vehicle 104. The representation 306 includes a 3D model of the refueling boom 106 registered with (such as overlayed on) real time scan data of the refueling boom 106.

The control unit 112 can also show locations on the display 116. For example, the control unit 112 receives flight data for the first vehicle 102, the second vehicle 104, and/or other vehicles. Based on artificial intelligence analysis of such data, the control unit 112 can then determine a refueling envelope for the second vehicle 104 in relation to the first vehicle 102 to create a crowd sourced knowledge base for refueling locations. As an example, the control unit 112 can show a preferable location 320 for refueling on the display 116. The preferable location 320 can be a location at which crowd sourced information shows a desirable altitude, wind conditions, weather conditions, and/or the like. The control unit 112 can also show a no-fly zone 322, which can be based on information received from other aircraft, for example. The control unit 112 can also show an inclement weather location 324 on the display 116. The first vehicle 102 and the second vehicle 104 can be manually or automatically operated to avoid the no-fly zone 322 and the inclement weather location 324, and instead maneuvered to the preferable location 320. The control unit 112 can also show an alternate location 326 for refueling on the display 116. The various locations, such as the preferable location 320, the no-fly zone 322, the inclement weather location 324, and the alternate location 326 can each be provided with unique, different indicia. For example, the preferable location 320 can be identified by text, graphics, and/or a color coding (such as green), while the no-fly zone 322 is identified with different indicia (such as a red color doing), the inclement weather location 324 is identified with different indicia (such as a yellow color coding), and the alternate location is identified with different indicia (such as grey color coding).

Optionally, the control unit 112 may not provide visual features, indicia, and/or the like on the display 116.

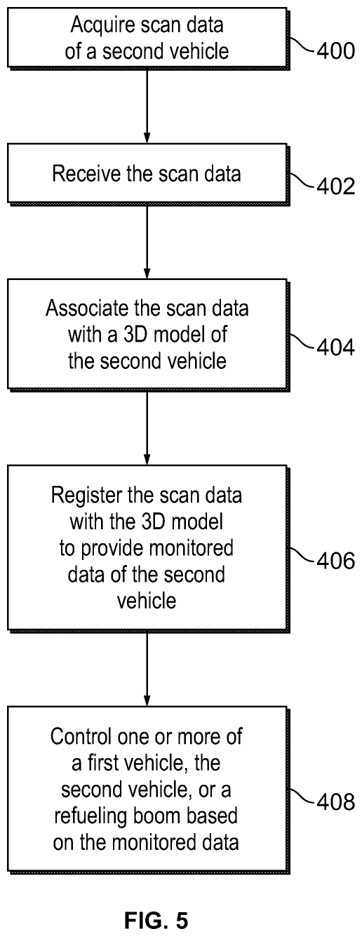

FIG. 5 illustrates a flow chart of a method, according to an example of the present disclosure. Referring to FIGS. 1 and 5, the system 100 is configured for allowing the first vehicle 102 to refuel the second vehicle 104. At 400, the sensors 110 acquire scan data of the second vehicle 104. The control unit 112 is in communication with the sensors 110. At 402, the control unit 112 receives the scan data of the second vehicle 104 from the sensors 110. At 404, the control unit 112 associates the scan data with a three-dimensional (3D) model of the second vehicle 104. At 406, the control unit 112 registers the scan data with the 3D model (for example, overlays the 3D model on the scan data) to provide monitored data of the second vehicle 104. At 408, the control unit 112 controls the first vehicle 102, the second vehicle 104, and/or the refueling boom 106 of the first vehicle 102 based on the monitored data.

Further, the disclosure comprises examples according to the following clauses:

Clause 1. A system configured for allowing a first vehicle to refuel a second vehicle, the system comprising:
sensors configured to acquire scan data of the second vehicle;
a control unit in communication with the sensors, wherein the control unit is configured to:
   receive the scan data of the second vehicle from the sensors,
   associate the scan data with a three-dimensional (3D) model of the second vehicle,
   register the scan data with the 3D model to provide monitored data of the second vehicle, and
   control one or more of the first vehicle, the second vehicle, or a refueling boom of the first vehicle based on the monitored data.

Clause 2. The system of Clause 1, wherein the control unit is configured to automatically control the first vehicle, the second vehicle, and the refueling boom based on the monitored data.

Clause 3. The system of Clauses 1 or 2, wherein the 3D model is previously stored in a model database.

Clause 4. The system of any of Clauses 1-3, wherein the control unit is further configured to generate the 3D model by recognizing one or more features within the scan data.

Clause 5. The system of Clause 4, wherein the one or more features are on a fuel port of the second vehicle.

Clause 6. The system of any of Clauses 1-5, wherein the first vehicle is a first aircraft, and the second vehicle is a second aircraft.

Clause 7. The system of any of Clauses 1-6, wherein the first vehicle comprises the sensors.

Clause 8. The system of any of Clauses 1-7, wherein the sensors do not include a photographic camera or a video camera.

Clause 9. The system of any of Clauses 1-8, wherein the sensors include one or more of light detection and ranging (LIDAR) sensors, lasers, infrared sensors, ultrasonic sensors, radio detection and ranging (RADAR) sensors, sound navigation ranging (SONAR) sensors, microwave sensors, or UHF/SHF/EHF, or THF frequency emission sensors.

Clause 10. The system of any of Clauses 1-9, further comprising a user interface including a display, wherein the control unit is further configured to show information regarding a refueling process on the display.

Clause 11. The system of Clause 10, wherein the control unit is further configured to show a preferable location for refueling on the display.

Clause 12. The system of any of Clauses 1-11, further comprising an imaging device that is separate and distinct from the sensors, wherein the imaging device is configured to acquire photographic images or video of the second vehicle.

Clause 13. The system of any of Clauses 1-12, wherein the control unit comprises an artificial intelligence or machine learning system.

Clause 14. The system of any of Clauses 1-13, wherein the control unit is further configured to record atmospheric data during each refueling operation to allow for artificial intelligence to learn and determine desired environments for future refueling operations.

Clause 15. A system comprising:
a first aircraft comprising a refueling boom and sensors;
a second aircraft comprising a fuel port;
a control unit in communication with the sensors, wherein the control unit comprises an artificial intelligence or machine learning system, and wherein the control unit is configured to:
   receive scan data of the second vehicle from the sensors,
   associate the scan data with a three-dimensional (3D) model of the second vehicle,
   register the scan data with the 3D model to provide monitored data of the second vehicle,
   control one or more of the first aircraft, the second aircraft, or a refueling boom of the first aircraft based on the monitored data, and
   record atmospheric data during each refueling operation to allow for the artificial intelligence or machine learning system to learn and determine desired environments for future refueling operations; and
a user interface including a display, wherein the control unit is further configured to show information regarding a refueling process on the display.

Clause 16. The system of Clause 15, wherein the control unit is configured to automatically control the first aircraft, the second aircraft, and the refueling boom based on the monitored data.

Clause 17. The system of Clauses 15 or 16, wherein the 3D model is previously stored in a model database.

Clause 18. The system of any of Clauses 15-17, wherein the control unit is further configured to generate the 3D model by recognizing one or more features within the scan data.

Clause 19. The system of any of Clauses 15-18, wherein the first aircraft further comprises an imaging device that is separate and distinct from the sensors, wherein the imaging device is configured to acquire photographic images or video of the second vehicle.

Clause 20. A method for allowing a first vehicle to refuel a second vehicle, the method comprising:
acquiring, by sensors of the first vehicle, scan data of the second vehicle;
receiving, by a control unit in communication with the sensors, the scan data of the second vehicle from the sensors;
associating, by the control unit, the scan data with a three-dimensional (3D) model of the second vehicle;
registering, by the control unit, the scan data with the 3D model to provide monitored data of the second vehicle; and
controlling, by the control unit, one or more of the first vehicle, the second vehicle, or a refueling boom of the first vehicle based on the monitored data.

Clause 21. The method of Clause 20, wherein said controlling comprises automatically controlling, by the control unit, the first vehicle, the second vehicle, and the refueling boom based on the monitored data.

Clause 22. The method of Clauses 20 or 21, further comprising generating, by the control unit, the 3D model by recognizing one or more features within the scan data.

Clause 23. The method of any of Clauses 20-22, further comprising showing, by the control unit, information regarding a refueling process on a display of a user interface.

Clause 24. The method of Clause 23, wherein said showing comprises showing a preferable location for refueling on the display.

Clause 25. The method of any of Clauses 20-24, further comprising recording, by the control unit, atmospheric data during each refueling operation to allow for artificial intelligence to learn and determine desired environments for future refueling operations.

As described herein, examples of the present disclosure provide improved systems and methods for refueling an aircraft during a flight. Further, examples of the present disclosure provide systems and methods for refueling an aircraft that eliminate, minimize, or otherwise reduce issues that could arise from potential distortions within acquired images.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system configured for allowing a first vehicle to refuel a second vehicle, the system comprising:
sensors configured to acquire scan data of the second vehicle;
a control unit in communication with the sensors, wherein the control unit is configured to:
receive the scan data of the second vehicle from the sensors,
associate the scan data with a three-dimensional (3D) model of the second vehicle,
register the scan data with the 3D model to provide monitored data of the second vehicle, and
control one or more of the first vehicle, the second vehicle, or a refueling boom of the first vehicle based on the monitored data.

2. The system of claim 1, wherein the control unit is configured to automatically control the first vehicle, the second vehicle, and the refueling boom based on the monitored data.

3. The system of claim 1, wherein the 3D model is previously stored in a model database.

4. The system of claim 1, wherein the control unit is further configured to generate the 3D model by recognizing one or more features within the scan data.

5. The system of claim 4, wherein the one or more features are on a fuel port of the second vehicle.

6. The system of claim 1, wherein the first vehicle is a first aircraft, and the second vehicle is a second aircraft.

7. The system of claim 1, wherein the first vehicle comprises the sensors.

8. The system of claim 1, wherein the sensors do not include a photographic camera or a video camera.

9. The system of claim 1, wherein the sensors include one or more of light detection and ranging (LIDAR) sensors, lasers, infrared sensors, ultrasonic sensors, radio detection and ranging (RADAR) sensors, or sound navigation ranging (SONAR) sensors.

10. The system of claim 1, further comprising a user interface including a display, wherein the control unit is further configured to show information regarding a refueling process on the display.

11. The system of claim 10, wherein the control unit is further configured to show a preferable location for refueling on the display.

12. The system of claim 1, further comprising an imaging device that is separate and distinct from the sensors, wherein the imaging device is configured to acquire photographic images or video of the second vehicle.

13. The system of claim 1, wherein the control unit comprises an artificial intelligence or machine learning system.

14. The system of claim 1, wherein the control unit is further configured to record atmospheric data during each refueling operation to allow for artificial intelligence to learn and determine desired environments for future refueling operations.

15. A system comprising:
a first aircraft comprising a refueling boom and sensors;
a second aircraft comprising a fuel port;
a control unit in communication with the sensors, wherein the control unit comprises an artificial intelligence or machine learning system, and wherein the control unit is configured to:
receive scan data of the second vehicle from the sensors,
associate the scan data with a three-dimensional (3D) model of the second vehicle,
register the scan data with the 3D model to provide monitored data of the second vehicle,
control one or more of the first aircraft, the second aircraft, or a refueling boom of the first aircraft based on the monitored data, and
record atmospheric data during each refueling operation to allow for the artificial intelligence or machine learning system to learn and determine desired environments for future refueling operations; and
a user interface including a display, wherein the control unit is further configured to show information regarding a refueling process on the display.

16. The system of claim 15, wherein the control unit is configured to automatically control the first aircraft, the second aircraft, and the refueling boom based on the monitored data.

17. The system of claim 15, wherein the 3D model is previously stored in a model database.

18. The system of claim 15, wherein the control unit is further configured to generate the 3D model by recognizing one or more features within the scan data.

19. The system of claim 15, wherein the first aircraft further comprises an imaging device that is separate and distinct from the sensors, wherein the imaging device is configured to acquire photographic images or video of the second vehicle.

20. A method for allowing a first vehicle to refuel a second vehicle, the method comprising:
acquiring, by sensors of the first vehicle, scan data of the second vehicle;
receiving, by a control unit in communication with the sensors, the scan data of the second vehicle from the sensors;
associating, by the control unit, the scan data with a three-dimensional (3D) model of the second vehicle;
registering, by the control unit, the scan data with the 3D model to provide monitored data of the second vehicle; and
controlling, by the control unit, one or more of the first vehicle, the second vehicle, or a refueling boom of the first vehicle based on the monitored data.
